(19) United States
(12) Patent Application Publication
(10) Pub. No.: US 2018/0374435 A1
(43) Pub. Date: Dec. 27, 2018

(54) Display Apparatus and Method for Driving the Same

(71) Applicants: HKC Corporation Limited, Shenzhen (CN); Chongqing HKC Optoelectronics Technology Co., Ltd., Chongqing (CN)

(72) Inventor: Yu-Jen Chen, Chongqing (CN)

(21) Appl. No.: 15/743,963

(22) PCT Filed: May 26, 2017
(86) PCT No.: PCT/CN2017/086129

§ 371 Date: Jan. 11, 2018

(30) Foreign Application Priority Data
Dec. 20, 2016 (CN) 201611187836.2

(51) Int. Cl. G09G 3/36

(52) U.S. Cl. CPC G09G 3/3607; G09G 3/3696; G09G 2300/0452; G09G 2360/16; G09G 2320/0666; G09G 2320/0242

(57) ABSTRACT

The present disclosure provides a display apparatus and a method for driving the same. A method for driving a display apparatus includes: dividing blue sub-pixels on a display panel into a plurality of sub-pixel groups; the sub-pixel groups include an even number of sequentially adjacent blue sub-pixels; calculating an average gray scale value of each of the sub-pixel groups according to an image input signal; obtaining a driving voltage pair corresponding to the average gray scale value of each of the sub-pixel groups; the driving voltage pair includes a high driving voltage and a low driving voltage; and driving the blue sub-pixel of the sub-pixel group corresponding to the driving voltage pair.

### CROSS REFERENCE TO RELATED APPLICATION

This application claims priority to Chinese Patent Application No. 201611187836.2, entitled “LIQUID CRYSTAL DISPLAY APPARATUS AND METHOD FOR DRIVING THE SAME” filed on Dec. 20, 2016, the contents of which is expressly incorporated by reference herein in its entirety.

### FIELD OF THE INVENTION

The present disclosure relates to a field of liquid crystal display (LCD) technology, and particularly relates to a display apparatus and a method for driving the same.

### BACKGROUND OF THE INVENTION

Most conventional large-sized display apparatuses adopt negative vertical alignment (VA) liquid crystal technology or in-plane switching (IPS) liquid crystal technology. As to the driving of a VA liquid crystal in a large viewing angle, the brightness is rapidly saturated with the driving voltage, so that the viewing angle color shift is serious and the quality of the image is affected. Since a tendency of brightness saturation of a blue sub-pixel in the side view with the increasing of the gray scale is rapider and more pronounced than that of a red sub-pixel and a green sub-pixel, the quality of an image will show a significant deficiency of blue color shift in the mixed color view.

### SUMMARY

According to various embodiments of the present disclosure, a display apparatus and a method for driving the same are provided, which can improve the deficiency of viewing angle color cast.

A method for driving a display apparatus includes:

dividing blue sub-pixels on a display panel into a plurality of sub-pixel groups; the sub-pixel groups includes an even number of sequentially adjacent blue sub-pixels;

calculating an average gray scale value of each of the sub-pixel groups according to image input signal;

obtaining a corresponding driving voltage pair according to the average gray scale value of each of the sub-pixel groups; the driving voltage pair includes a high driving voltage and a low driving voltage; and

driving the blue sub-pixels on the corresponding sub-pixel group according to the driving voltage pair.

According to an embodiment, in the step of dividing the blue sub-pixels on the display panel into the plurality of sub-pixel groups, each of the sub-pixel groups includes the even number of sequentially and laterally adjacent blue sub-pixels or sequentially and vertically adjacent blue sub-pixels.

According to an embodiment, the step of looking up a table to obtain the corresponding driving voltage pair according to the average gray scale value of each of the sub-pixel groups includes:

determining a gray scale range of the average gray scale value of each of the sub-pixel groups;

obtaining a corresponding Look Up Table (LUT) according to the gray scale range;

obtaining the driving voltage pair using the corresponding LUT according to the average gray scale value of each of the sub-pixel groups.

According to an embodiment, prior to the step of determining the gray scale range of the average gray scale value of each of the sub-pixel groups, the method further comprises the step of dividing the gray scale values of the blue sub-pixels into a preset number of gray scale ranges; the different gray scale ranges correspond to the different LUTS.

According to an embodiment, the method further includes a step of prestoring a correspondence table between the different gray scale ranges and the LUT, and prestoring the LUT.

According to an embodiment, the step of driving the blue sub-pixels on the corresponding sub-pixel group according to the driving voltage pair includes:

dividing each of the sub-pixel groups into two adjacent sub-pixel units; and

driving the two adjacent sub-pixel units by the driving voltage pair, respectively.

According to an embodiment, in the step of driving the two adjacent sub-pixel units by the driving voltage pair, respectively, the driving voltages of the two adjacent sub-pixel units are different.

According to an embodiment, each of the sub-pixel groups includes two laterally adjacent blue sub-pixels or two vertically adjacent blue sub-pixels; the driving voltage pair is used to drive the two blue sub-pixels, respectively.

According to an embodiment, the driving voltage pair is used to drive the two blue sub-pixels, respectively, and the driving voltage pair of two adjacent blue sub-pixels includes a high driving voltage and a low driving voltage.

A display apparatus includes:

a display panel, including blue sub-pixels, the blue sub-pixels are divided into a plurality of sub-pixel groups; each of the sub-pixel groups includes an even number of sequentially adjacent blue sub-pixels;

a control element including one or more processors, and memory storing computer executable instructions, when the computer executable instructions are executed by the one or more processors, the one or more processors perform steps including:

receiving an image input signal and calculating an average gray scale value of each of the sub-pixel groups according to the image input signal; and

obtaining a corresponding driving voltage pair according to the average gray scale value; the driving voltage pair includes a high driving voltage and a low driving voltage; and

a driving element connected to the control element and the display panel, respectively; the driving element is used to drive the blue sub-pixels on the corresponding sub-pixel group according to the driving voltage pair.

According to an embodiment, each of the sub-pixel groups on the display panel includes an even number of sequentially and laterally adjacent blue sub-pixels or sequentially and vertically adjacent blue sub-pixels.

According to an embodiment, the one or more processors further execute the computer executable instructions to perform steps in following units:

a determining unit used to determine a gray scale range of the average gray scale value of each of the sub-pixel groups;

an obtaining unit used to obtain a corresponding LUT according to the gray scale range;

the obtaining unit is further used to obtain the driving voltage pair using the corresponding LUT according to the average gray scale value of each of the sub-pixel groups.

According to an embodiment, the display apparatus further includes a memory, and the memory is used to prestore a correspondence table between the different gray scale ranges and the LUTS and prestore the LUT.

According to an embodiment, each of the sub-pixel groups on the display panel is divided into two adjacent sub-pixels, the driving element is used to drive the two adjacent sub-pixel units according to the driving voltage pair, respectively.

According to an embodiment, when the driving element drives the two adjacent sub-pixel units according to the driving voltage pair, respectively, the driving voltages controlling two adjacent sub-pixel units are different.

According to an embodiment, each of the sub-pixel groups on the display panel includes two laterally adjacent blue sub-pixels or two vertically adjacent blue sub-pixels; the driving element is used to drive the two blue sub-pixels according to the driving voltage pair, respectively.

According to an embodiment, when the driving element is used to drive the two sub-pixels according to the driving voltage pair, respectively, the driving voltages controlling two adjacent blue sub-pixels are different.

According to an embodiment, the display panel is a flat display panel or a curved display panel.

A display apparatus includes:

a display panel, including blue sub-pixels, the blue sub-pixels are divided into a plurality of sub-pixel groups; each of the sub-pixel groups includes an even number of sequentially and laterally adjacent blue sub-pixels or sequentially and vertically adjacent blue sub-pixels; each of the sub-pixel groups is divided into two adjacent sub-pixel units;

a control element including one or more processors, and memory storing computer executable instructions, when the computer executable instructions are executed by the one or more processors, the one or more processors perform steps including:

receiving an image input signal and calculating an average gray scale value of each of the sub-pixel groups according to the image input signal; and

obtaining a corresponding driving voltage pair according to the average gray scale value; wherein the driving voltage pair includes a high driving voltage and a low driving voltage; and

a driving element connected to the control element and the display panel, respectively; wherein the driving element is used to drive two sub-pixel units of the corresponding sub-pixel group according to the driving voltage pair;

the one or more processors further execute the computer executable instructions to perform steps in the following units:

a determining unit used to determine a gray scale range of the average gray scale value of each of the sub-pixel groups;

an obtaining unit used to obtain a corresponding LUT according to the gray scale range;

the obtaining unit is further used to obtain the driving voltage pair using the corresponding LUT according to the gray scale range of each of the sub-pixel groups.

According to the aforementioned display apparatus and the method for driving the same, the driving voltage pair having a high voltage and a low voltage is selected to perform the driving according to the gray scale range of the average gray scale value of each of the sub-pixel groups on the display panel. By driving the blue sub-pixel in each of the sub-pixel groups via the high and low voltage, the brightness variation of the blue sub-pixels in the side view can be controlled. Therefore a saturation tendency of the blue sub-pixels in the side view is approximate to the red sub-pixels and the blue sub-pixels or is approximate to a tendency of brightness saturation curves of the red sub-pixels, green sub-pixels, and the blue sub-pixels in the front view, thereby reducing the deficiency of the viewing color shift. At the same time, a plurality of driving voltage pairs are formed to drive the blue sub-pixels, which can ensure that the brightness of the adjusted image is approximate to a target brightness, the deficiency of color shift caused by premature saturation of blue sub-pixels in the large view can be effectively improved.

### BRIEF DESCRIPTION OF THE DRAWINGS

To illustrate the technical solutions according to the embodiments of the present disclosure or in the prior art more clearly, the accompanying drawings for describing the embodiments or the prior art are introduced briefly in the following. The accompanying drawings in the following description are only some embodiments of the present invention, and persons of ordinary skill in the art can derive other obvious variations from the accompanying drawings without creative efforts.

FIG. 1 is a flowchart of a method for driving a display apparatus according to an embodiment;

FIGS. 2 to 5 are schematic diagrams of dividing blue sub-pixels on a display panel according to different embodiments;

FIG. 6 is a specific flowchart of step S130 in FIG. 1;

FIG. 7 is a graphic diagram illustrating a comparison of curves of brightness of the blue sub-pixels varying with gray scale in the front view and in the side view when adopting a single driving voltage to perform the driving;

FIG. 8 is a graphic diagram illustrating curves of the brightness of the blue sub-pixels varying with the gray scale in the side view when adopting a high driving voltage, a low driving voltage, and a high and low driving voltage pair to perform the driving, respectively;

FIGS. 9 and 10 are schematic diagrams illustrating driving after S140 is performed;

FIG. 11 is a graphic diagram illustrating a comparison of a curve of ideal brightness varying with the gray scale and curves of a respective brightness of two voltages in combination varying with the gray scale;

FIGS. 12 and 13 are partial enlarged views of FIG. 11;

FIG. 14 is a block diagram of the display apparatus according to an embodiment; and

FIG. 15 is a block diagram of a control element according to an embodiment.

### DETAILED DESCRIPTION OF THE EMBODIMENTS

Embodiments of the present disclosure are described more fully hereinafter with reference to the accompanying drawings, in which some embodiments of the present disclosure are shown. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

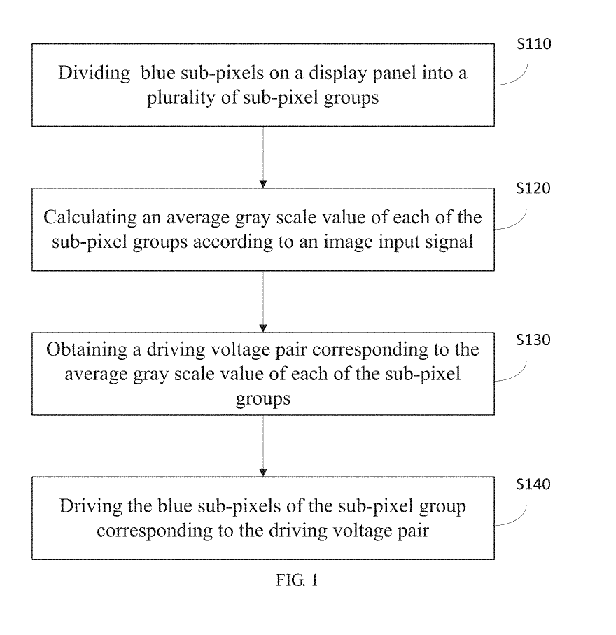

FIG. 1 is a flowchart of a method for driving a display apparatus according to an embodiment. The method for driving the display apparatus can improve the deficiency of color shift (or color aberration) caused by refractive index mismatch of the liquid crystal in the large view. The display apparatus can be a liquid crystal display (LCD) apparatus, an organic light emitting diode (OLED) display apparatus, a quantum light emitting diode (QLED) display apparatus and so on, whilst the display apparatus can be a flat display apparatus or a curved display apparatus. It should be noted that the display apparatus includes the aforementioned examples but is not limited thereto. When the display apparatus is the LCD apparatus, it can be the LCD apparatus such as a twisted nematic (TN), an optically compensated bend (OCB), or a vertical alignment (VA) apparatus. The backlight of the LCD may apply direct-lit backlight, the backlight source can be a white light source, a RGB three color light source, a RGBW four color light source or a RGBY four color light source, but is not limited thereto. Referring to FIG. 1, the method for driving the display apparatus includes the following steps:

In step S110, blue sub-pixels on a display panel are divided into a plurality of sub-pixel groups.

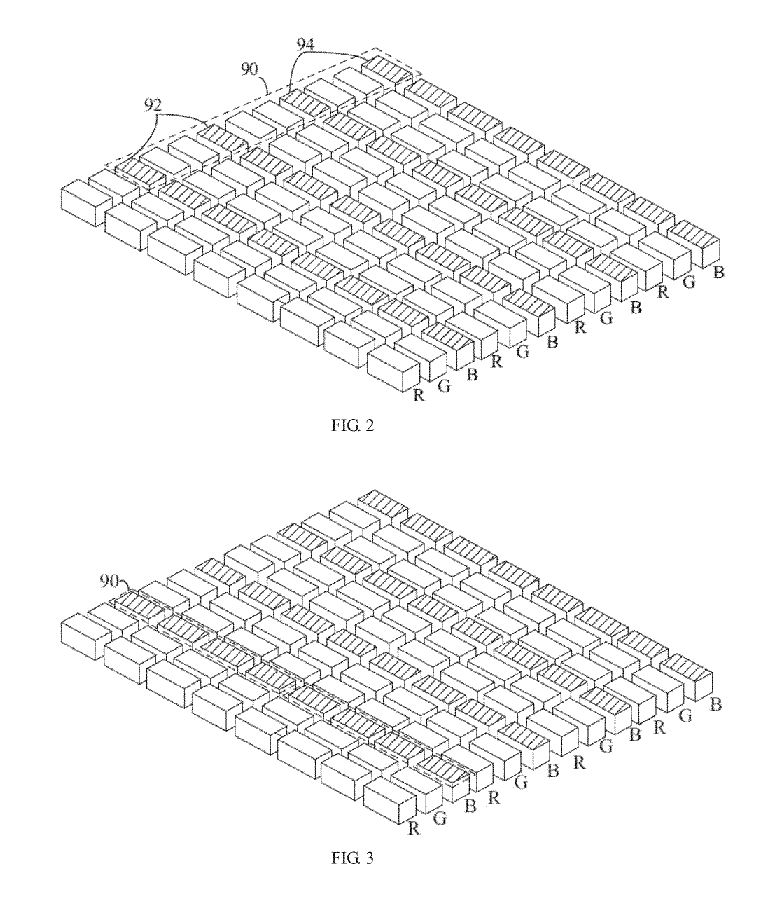

After division, each of the sub-pixel groups includes an even number of sequentially adjacent blue sub-pixels. Specifically, an even number of blue sub-pixels can be sequentially and laterally adjacent or sequentially and vertically adjacent. FIG. 2 is a schematic diagram of dividing the blue sub-pixels according to an embodiment. In the illustrated embodiment, each of the sub-pixel groups 90 includes four laterally adjacent pixels. And the four laterally adjacent blue sub-pixels are divided into two adjacent sub-pixel units 92 and 94. FIG. 3 is a schematic diagram of dividing the blue sub-pixels according to another embodiment. In the illustrated embodiment, each of the sub-pixel groups 90 includes four vertically adjacent blue sub-pixels. FIG. 4 is a schematic diagram of dividing the blue sub-pixels according to yet another embodiment. In the illustrated embodiment, each of the sub-pixel groups 90 includes two laterally adjacent blue sub-pixels. In an alternative embodiment, each of the sub-pixel groups 90 includes two vertically adjacent blue sub-pixels, as shown in FIG. 5. It should be noted that the method of dividing the blue sub-pixels on the display panel includes the aforementioned example but is not limited thereto.

In step S120, an average gray scale value of each of the sub-pixel groups is calculated according to an image input signal.

The gray scale value of each blue sub-pixel is represented by Bn, where B represents blue, n represents a serial number of the blue sub-pixel in the entire display panel. In the illustrated embodiment, taking the division in FIG. 4 and FIG. 5 as an example, the average gray scale value of each of the sub-pixel groups is an average value of two blue sub-pixels Bn and Bn+1, i.e.:

B′n=Average(Bn+Bn+l), n=1, 3, 5 . . . .

In step S130, a corresponding driving voltage pair is obtained according to the average gray scale value of each of the sub-pixel groups.

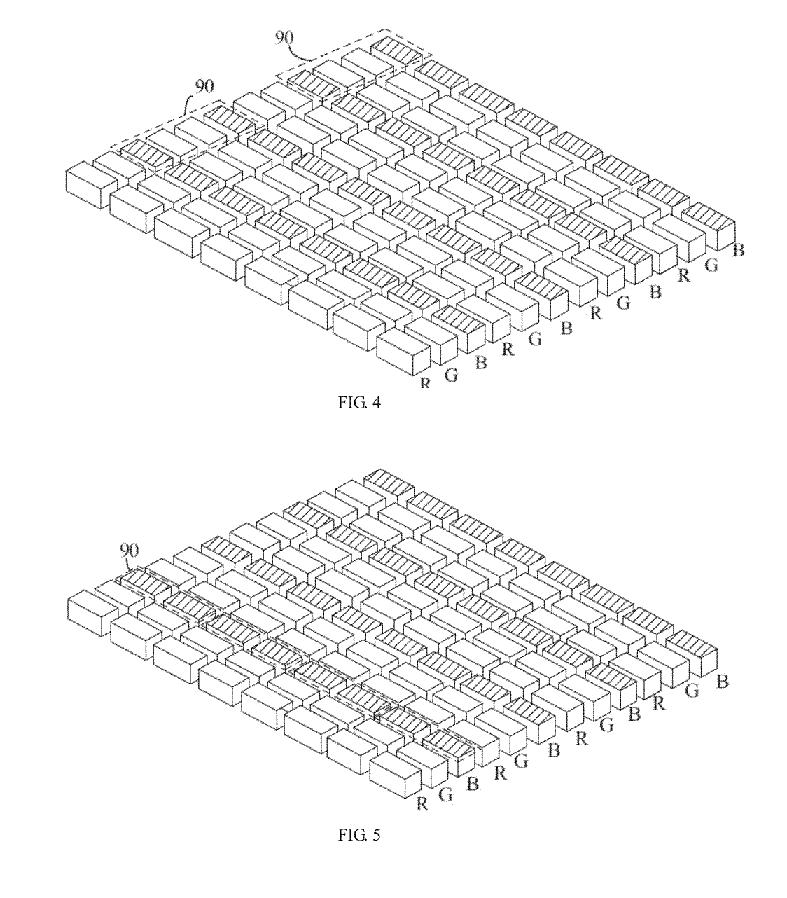

FIG. 6 is a specific flowchart of obtaining the corresponding driving voltage pair, which includes the following sub-steps:

In step S210, a gray scale range of the average gray scale value of each of the sub-pixel groups is determined.

Prior to determining the gray scale range of the average gray scale value of each of the sub-pixel groups, the gray scale values of the blue sub-pixels are divided into a preset number of gray scale ranges beforehand, such as 0 to 50, 51 to 101, 102 to 152, 153 to 203, and 204 to 255. It should be noted that the gray scale range can be divided according to an actual requirement but is not limited thereto. Each of the gray scale ranges can be determined according to the extent to which the color cast needs to be improved.

In step S220, a Look Up Table (LUT) corresponding to the gray scale range is obtained.

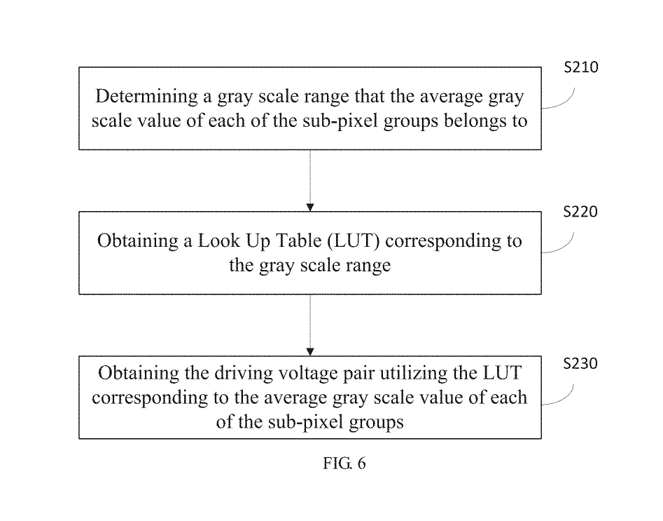

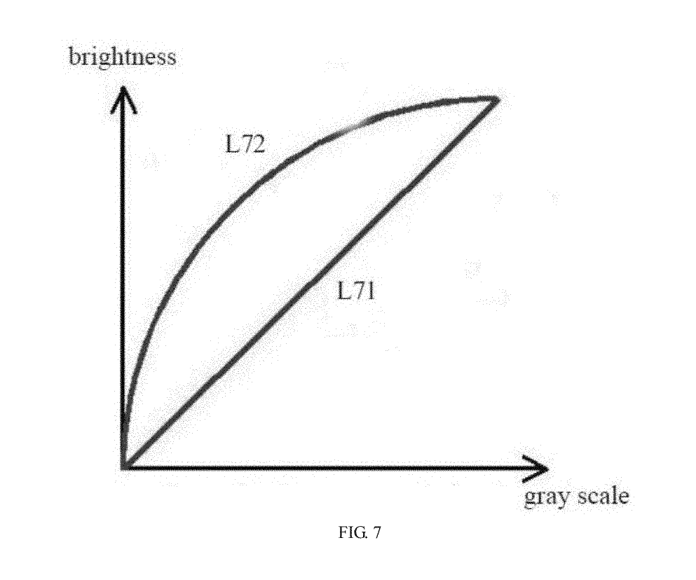

The LUT is a correspondence table of color gray scale values of the input signals of the blue sub-pixels and the driving voltage pairs. The driving voltage pair includes a high driving voltage and a low driving voltage, i.e., consists of the high driving voltage B′H and the low driving voltage B′L, i.e., the color gray scale value 0 to 255 of the blue sub-pixel correspond to 256 pair high and low driving voltage signals. Each group of the high and low driving voltage is capable of making a curve of brightness of the adjusted blue sub-pixel varying with the gray scale in the side view more approximate to a curve of brightness of the adjusted blue sub-pixel varying with the gray scale in the front view. By driving the blue sub-pixel in each of the sub-pixel groups via the high and low voltage, the brightness variation of the blue sub-pixels in the side view can be controlled. Therefore a saturation tendency of the blue sub-pixel in the side view is approximate to the red sub-pixels and the blue sub-pixels or is approximate to a tendency of brightness saturation curves of the red sub-pixels, the green sub-pixels, and the blue sub-pixels in the front view, thereby reducing the deficiency of the viewing color shift. FIG. 7 is a curve of the brightness of the blue sub-pixels varying with the gray scale value in the front view and in the side view when a single driving voltage is adopted. Specifically, L71 represents a curve in the front view, and L72 represents a curve in the side view. Apparently, it is easy that the curve of the brightness of the blue sub-pixel varying with the gray scale value tends to be saturated easily in the side view, so that the quality of an image will show a significant deficiency of a bluish color shift in the mixed color view. FIG. 8 is a graphic diagram illustrating a comparison of the brightness variation curves in the side view when a high voltage driving and a low voltage driving are adopted, and when a high and low driving voltage pair is adopted to perform the driving. Specifically, L81 is a curve of brightness varying with the gray scale in the side view when a high voltage is used to drive. L82 is a curve of brightness varying with the gray scale in the side view when a low voltage is used to drive. L83 is a combination of L81 and L82, i.e., a curve of brightness varying with the gray scale after the high and low driving voltage pair is adopted, which is apparently more approximate to the curve L84 of the brightness varying with the gray scale in the front view, i.e., the viewing angle color shift is improved after the high and low voltage pair is adopted.

The different gray scale ranges have different effect on the viewing angle color shift, so that the different gray scale ranges correspond to the different LUTS. Therefore, the different gray scale values can be driven by a more suitable drive voltage pair corresponding to the gray scale values, which ensures that the brightness of the adjusted blue sub-pixel varying with gray scale in the side view is more approximate to the variation curve in the front view. There is a one-to-one correspondence between the LUT and the hue range, and the correspondence table can be stored beforehand. The correspondence table and the LUT can be stored in a memory at the same time, or stored respectively. The memory may be a storage apparatus within the display apparatus, or may be stored directly by an external storage apparatus which can be accessed externally if necessary. Therefore, the corresponding LUT can be readily determined according to the obtained hue range of respective pixel group.

In step S230, the driving voltage pair is obtained by using the corresponding LUT according to the average gray scale value of each of the sub-pixel groups.

The different gray scale ranges correspond to the different LUTS, so that the final obtained driving voltage pair is much more approximate to the ideal driving voltage, therefore the brightness variation of the adjusted blue sub-pixel is much more approximate to the ideal condition.

In step S140, the blue sub-pixels on the corresponding sub-pixel group are driven according to the driving voltage pair.

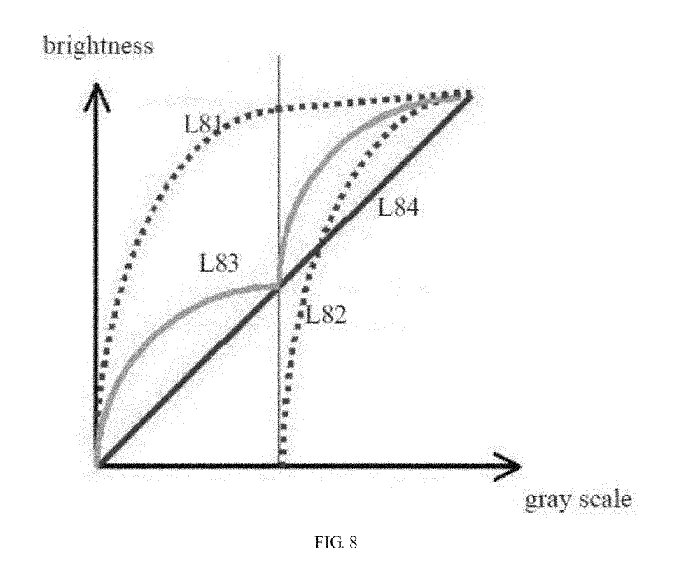

In the illustrated embodiment, the driving voltage pair is used to drive the two sub-pixel units, respectively. The high driving voltage drives one of the sub-pixel unit, and the low driving voltage drives the other sub-pixel unit so as to achieve the high and low interphase voltages driving of the adjacent blue sub-pixels, as shown in FIGS. 9 and 10. In the driving method of the illustrated embodiment, the other sub-pixels such as the red sub-pixel or the green sub-pixel can be driven according to a usual driving method.

According to the aforementioned method for driving the display apparatus, the corresponding driving voltage pair having a high voltage and a low voltage is obtained to perform the driving according to the gray scale range of the average gray scale value of each of the sub-pixel groups on the display panel. In the illustrated embodiment, the blue sub-pixels are driven on a space by the high and low interphase voltages at the cost of sacrificing the resolution of the blue sub-pixels, which are relatively less sensitive to eyes, such that the brightness variation of the blue sub-pixels in the side view can be controlled. Therefore a saturation tendency of the blue sub-pixel in the side view is approximate to the red sub-pixels and the blue sub-pixels or is approximate to a tendency of brightness saturation curves of the red sub-pixels, the green sub-pixels, and the blue sub-pixels in the front view, thereby reducing the deficiency of the viewing color shift. At the same time, by forming a plurality of driving voltage pairs to drive the blue sub-pixels, the brightness of the adjusted image is approximate to a target brightness. Therefore the deficiency of color shift caused by premature saturation of blue sub-pixel in the large view can be effectively improved.

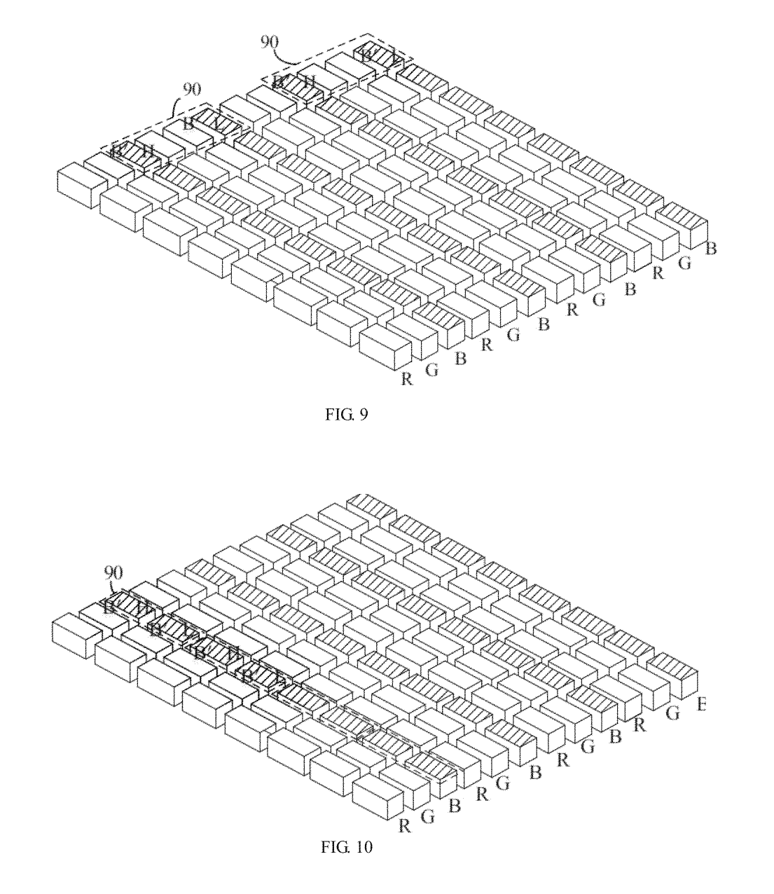

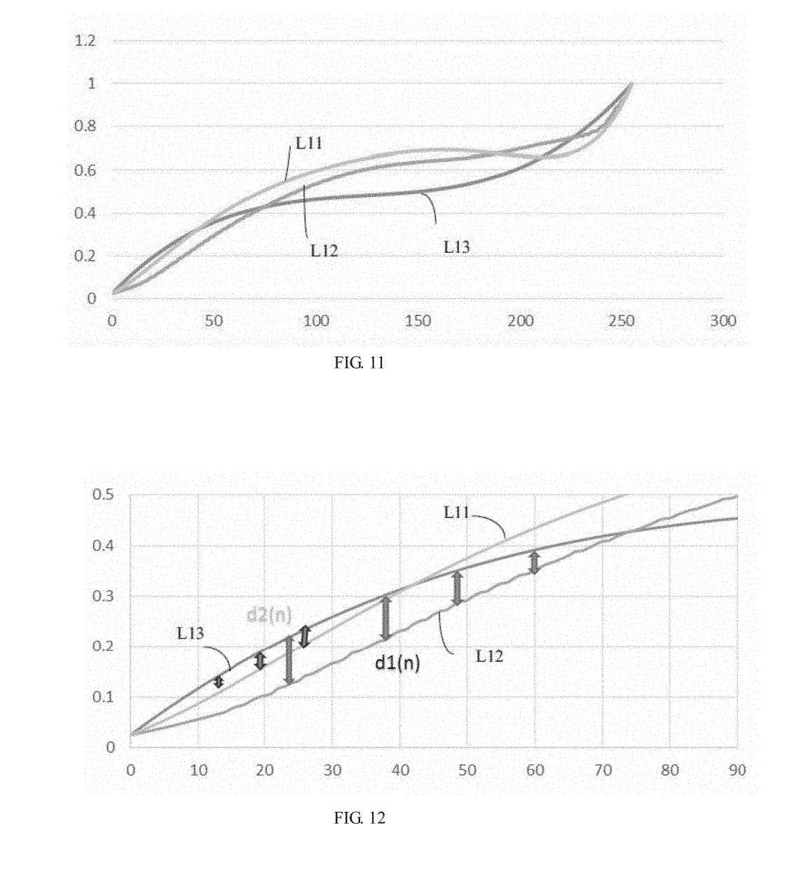

According to the mentioned driving method, by dividing each blue sub-pixel on the display panel into the plurality of groups, each of the sub-pixel groups can be driven by adopting different high and low driving voltage pairs according to the actual gray value, thereby reducing the deficiency of the viewing color shift. The importance of performing the driving by the plurality of groups of driving voltages respectively will be described with reference to the FIGS. 11 to 13 hereinafter. Referring to FIG. 11, target gamma is a curve of brightness of a target blue sub-pixel varying with the gray scale value, which corresponds to L13 in FIG. 11. The dividing of the blue sub-pixel has to satisfy a condition that the ratio of the RGB brightness does not change in the front view. There are several combinations of high and low voltage signals divided by the blue sub-pixel space, and the condition that the brightness saturation varying with the voltage in the side view caused by each combination is different. Referring to FIG. 12, the high and low voltage combinations, gamma1 and gamma2, which are divided by the blue sub-pixel space and for which the brightness is saturated and varies with voltage in the side view correspond to L12 and L11 in the drawing, respectively. FIGS. 12 and 13 are partial enlarged views of the FIG. 11. It can be seen from the FIGS. 11 to 13, when a group of a high and low voltage pair is adopted to drive the blue sub-pixels on the display panel, the saturation tendency of the curve of the brightness varying with the gray scale is rapider than that of the Target gamma, and therefore the problem of the side viewing angle color shift cannot be satisfactorily solved, i.e., the combination of the high voltage and the low voltage merely divided by one blue sub-pixel space cannot satisfy the requirement that the brightness of the high and low voltages is approximate to the target brightness at the same time.

As shown in FIG. 12, when a relation of variation between the low voltage (corresponding to the low gray scale value) and the brightness is considered, the difference d1(n) between the actual brightness of the gamma1 and the target brightness is much larger than the difference d2(n) between the actual brightness of the gamma2 and the target brightness. However, as shown in FIG. 13, when a relation of variation between the high voltage (corresponding to the high gray scale value) and the brightness is considered, the difference d1(n) between the actual brightness of the gamma1 and the target brightness is much smaller than the difference d2(n). That is, the gamma1 is suitable for a condition when the blue sub-pixel higher voltage signal (i.e., the gray scale value of the blue sub-pixel is higher) is presented on the image content. On the other hand, the gamma2 is suitable for a condition when the blue sub-pixel lower voltage signal (i.e., the gray scale value of the blue sub-pixel is lower) is presented on the image content. The driving method of the illustrated embodiment, which adopts different combinations of the high and low voltage to perform the driving for the different gray scale values, so that the aforementioned problem can be overcome, effectively. Moreover, after the aforementioned driving method is adopted, the pixels on the display panel need not be designed as a primary pixel and a secondary pixel, thereby greatly improving the penetration and resolution of a thin film transistor (TFT) display panel, and reducing the design costs of backlight.

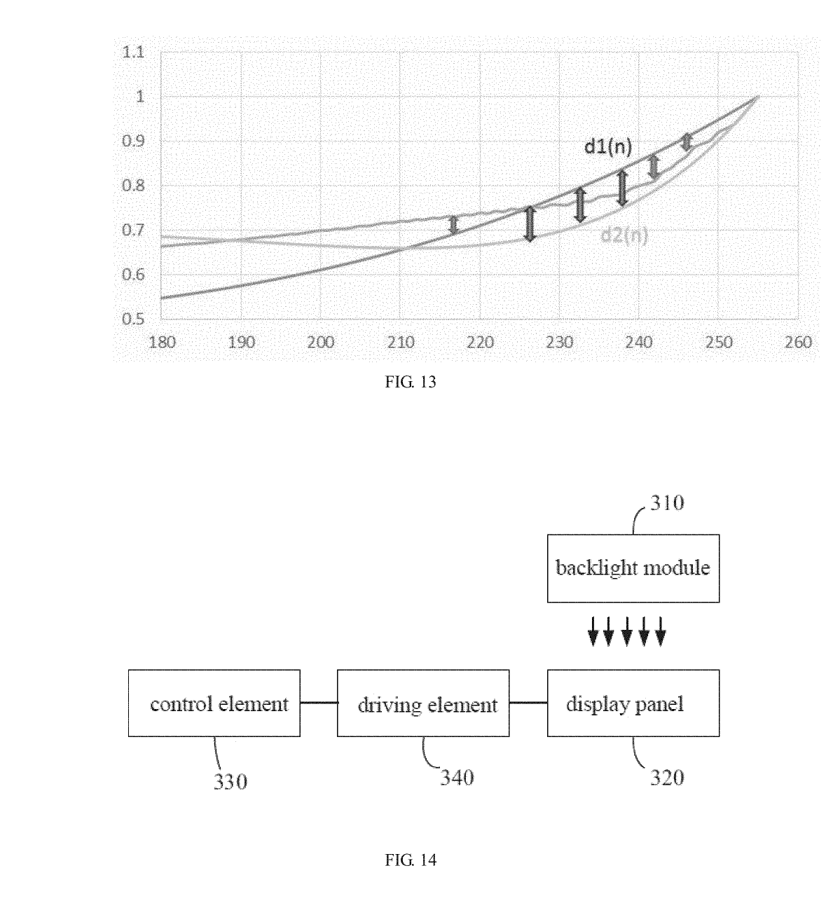

The present disclosure also provides a display apparatus, as shown in FIG. 14. The display apparatus can perform the aforementioned driving method. The display apparatus includes a backlight module 310, a display panel 320, a control element 330, and a driving element 340. The control element 330 and the driving element 340 can be both integrated into the display panel 320, however, the backlight module 310 can be implemented by adopting an independent backlight module, directly. It should be noted that the manner of integrating the respective elements is not limited thereto. In an alternative embodiment, the display apparatus may not include the backlight module 310, so that the backlight is provided to the display apparatus by the independent backlight module 310.

The backlight module 310 is used to provide the backlight. The backlight module 310 can be direct-lit backlight or side-lit backlight. The backlight source can be a white light source, a RGB three color light source, a RGBW four color light source or a RGBY four color light source, but is not limited thereto.

The display panel 320 can be a liquid crystal display (LCD) panel, an organic light emitting diode (OLED) display panel, a quantum light emitting diode (QLED) display panel and so on, and at the same time, the display panel 320 can be a flat display panel or a curved display panel. It should be noted that the display panel includes the aforementioned examples but is not limited thereto. When the display panel 320 is the LCD panel, it can be an LCD panel such as the TN, the OCB, or the VA apparatus. In the illustrated embodiment, the blue sub-pixels on the display panel 320 are divided into a plurality of pixel groups. Each of the pixel groups includes an even number of sequentially adjacent blue sub-pixels. The dividing method can be referred to FIGS. 2 to 5, but is not limited thereto.

The control element 330 includes one or more processors and a memory storing computer executable instructions, and when the computer executable instructions are executed by the one or more processors, the one or more processors perform steps including: receiving an image input signal and calculating an average gray scale value of each of the sub-pixel groups according to the image input signal; and obtaining a driving voltage pair corresponding to the average gray scale value. The driving voltage pair includes a high driving voltage and a low driving voltage. A determining unit 332 is used to determine a gray scale range of the average gray scale value of each of the sub-pixel groups.

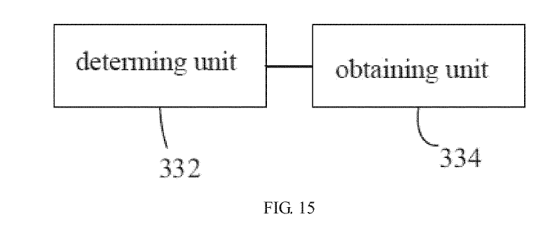

Specifically, the one or more processors further execute the computer executable instructions to perform steps in following units as shown in FIG. 15. Prior to determining the gray scale range of the average gray scale value of each of the sub-pixel groups, the gray scale values of the blue sub-pixels are divided into a preset number of gray scale ranges beforehand. An obtaining unit 332 is used to obtain a LUT corresponding to the gray scale range, and is used to obtain the driving voltage pair using the LUT corresponding to the average gray scale value of each of the sub-pixel groups. There is a one-to-one correspondence between the LUT and the gray scale range, and the correspondence table can be stored beforehand. The LUT is a correspondence table of color gray scale values of the input signals of the blue sub-pixels and the driving voltage pairs. The driving voltage pair includes a high driving voltage and a low driving voltage. The correspondence table and the LUT can be stored in a memory at the same time, or stored respectively. The memory may be a storage apparatus within the display apparatus, or may be stored directly by an external storage apparatus which can be accessed externally if necessary. Therefore, the corresponding LUT can be readily determined according to the obtained gray scale range.

The driving element 340 is connected to the control element 330 and the display panel 320, respectively. The driving element 330 is used to drive the blue sub-pixels of the sub-pixel group according to the driving voltage pair.

According to the aforementioned display apparatus, the corresponding driving voltage pair having a high voltage and a low voltage is obtained to perform the driving according to the gray scale range of the average gray scale value of each of the sub-pixel groups on the display panel 320. By driving each of the sub-pixel groups via the high and low voltage, such that the brightness variation of the blue sub-pixels in the side view can be controlled. Therefore a saturation tendency of the blue sub-pixel in the side view is approximate to the red sub-pixels and the blue sub-pixels or is approximate to a tendency of brightness saturation curves of the red sub-pixels, the green sub-pixels, and the blue sub-pixels in the front view, thereby reducing the deficiency of the viewing color shift. At the same time, by forming a plurality of driving voltage pairs to drive the blue sub-pixel, which can ensure that the brightness of the adjusted image is approximate to a target brightness, and the deficiency of color shift caused by premature saturation of blue sub-pixels in the large view can be effectively improved.

Those of ordinary skills in the art can understand that the total or partial process of the aforementioned method can be achieved by an associated hardware instructed by a computer program. The program may be stored in a computer-readable storage medium. When the program is executed, the program can include the aforementioned process of the aforementioned embodiment of the methods. The storage medium may be a nonvolatile storage medium such as a magnetic disk, an optical disk, a read-only memory (ROM), or a random access memory (RAM).

The different technical features of the above embodiments can have various combinations which are not described for the purpose of brevity. Nevertheless, to the extent the combining of the different technical features does not conflict with each other, all such combinations must be regarded as within the scope of the disclosure.

The foregoing implementations are merely specific embodiments of the present disclosure, and are not intended to limit the protection scope of the present disclosure. It should be noted that any variation or replacement readily figured out by persons skilled in the art within the technical scope disclosed in the present disclosure shall all fall within the protection scope of the present disclosure. Therefore, the protection scope of the present disclosure shall be subject to the protection scope of the claims.

What is claimed is:

1. A method for driving a display apparatus, comprising:
dividing blue sub-pixels on a display panel into a plurality of sub-pixel groups, wherein the sub-pixel groups comprises an even number of sequentially adjacent blue sub-pixels;
calculating an average gray scale value of each of the sub-pixel groups according to an image input signal;
obtaining a corresponding driving voltage pair according to the average gray scale value of each of the sub-pixel groups, wherein the driving voltage pair comprises a high driving voltage and a low driving voltage; and
driving the blue sub-pixels on the corresponding sub-pixel group according to the driving voltage pair.

2. The method according to claim 1, wherein in the step of dividing the blue sub-pixels on the display panel into the plurality of sub-pixel groups, each of the sub-pixel groups comprises the even number of sequentially and laterally adjacent blue sub-pixels or sequentially and vertically adjacent blue sub-pixels.

3. The method according to claim 1, wherein the step of looking up a table to obtain the corresponding driving voltage pair according to the average gray scale value of each of the sub-pixel groups comprises:
determining a gray scale range of the average gray scale value of each of the sub-pixel groups;
obtaining a corresponding Look Up Table (LUT) according to the gray scale range;
obtaining the driving voltage pair using the corresponding LUT according to the average gray scale value of each of the sub-pixel groups.

4. The method according to claim 3, wherein prior to the step of determining the gray scale range of the average gray scale value of each of the sub-pixel groups, the method further comprises a step of dividing the gray scale values of the blue sub-pixels into a preset number of gray scale ranges; the different gray scale ranges correspond to the different LUTS.

5. The method according to claim 4, wherein the method further comprises a step of prestoring a correspondence table between the different gray scale ranges and the LUTS, and prestoring the LUT.

6. The method according to claim 1, wherein the step of driving the blue sub-pixels on the corresponding sub-pixel group according to the driving voltage pair comprises:
dividing each of the sub-pixel groups into two adjacent sub-pixel units; and
driving the two adjacent sub-pixel units by the driving voltage pair, respectively.

7. The method according to claim 6, wherein in the step of driving the two adjacent sub-pixel units by the driving voltage pair, respectively, the driving voltages of the two adjacent sub-pixel units are different.

8. The method according to claim 6, wherein each of the sub-pixel groups comprises two laterally adjacent blue sub-pixels or two vertically adjacent blue sub-pixels; the driving voltage pair is configured to drive the two blue sub-pixels, respectively.

9. The method according to claim 8, wherein the driving voltage pair is configured to drive the two blue sub-pixels, respectively, and the driving voltage pair of two adjacent blue sub-pixels comprises a high driving voltage and a low driving voltage.

10. A display apparatus comprising:
a display panel, comprising blue sub-pixels, wherein the blue sub-pixels are divided into a plurality of sub-pixel groups; each of the sub-pixel groups comprises an even number of sequentially adjacent blue sub-pixels;
a control element comprising one or more processors, and a memory storing computer executable instructions, wherein when the computer executable instructions are executed by the one or more processors, the one or more processors perform steps comprising:
receiving an image input signal and calculating an average gray scale value of each of the sub-pixel groups according to the image input signal; and
obtaining a corresponding driving voltage pair according to the average gray scale value; wherein the driving voltage pair comprises a high driving voltage and a low driving voltage; and
a driving element connected to the control element and the display panel, respectively; wherein the driving element is configured to drive the blue sub-pixels on the corresponding sub-pixel group according to the driving voltage pair.

11. The display apparatus according to claim 10, wherein each of the sub-pixel groups on the display panel comprises an even number of sequentially and laterally adjacent blue sub-pixels or sequentially and vertically adjacent blue sub-pixels.

12. The display apparatus according to claim 10, wherein the one or more processors further execute the computer executable instructions to perform steps in following units:
a determining unit configured to determine a gray scale range of the average gray scale value of each of the sub-pixel groups;
an obtaining unit configured to obtain a corresponding LUT according to the gray scale range;
wherein the obtaining unit is further configured to obtain the driving voltage pair using the corresponding LUT according to the average gray scale value of each of the sub-pixel groups.

13. The display apparatus according to claim 12, further comprising a memory, wherein the memory is configured to prestore a correspondence table between the different gray scale ranges and the LUTS, and prestore the LUT.

14. The display apparatus according to claim 10, wherein each of the sub-pixel groups on the display panel is divided into two adjacent sub-pixel units, the driving element is configured to drive the two adjacent sub-pixel units according to the driving voltage pair, respectively.

15. The display apparatus according to claim 14, wherein when the driving element drives the two adjacent sub-pixel units according to the driving voltage pair, respectively, the driving voltages controlling two adjacent sub-pixel units are different.

16. The display apparatus according to claim 14, wherein each of the sub-pixel groups on the display panel comprises two laterally adjacent blue sub-pixels or two vertically adjacent blue sub-pixels; the driving element is configured to drive the two blue sub-pixels according to the driving voltage pair, respectively.

17. The display apparatus according to claim 16, wherein when the driving element is configured to drive the two sub-pixels according to the driving voltage pair, respectively, the driving voltages controlling two adjacent blue sub-pixels are different.

18. The display apparatus according to claim 10, wherein the display panel is a flat display panel or a curved display panel.

19. A display apparatus comprising:
a display panel, comprising blue sub-pixels, wherein the blue sub-pixels are divided into a plurality of sub-pixel groups; each of the sub-pixel groups comprises an even number of sequentially and laterally adjacent blue sub-pixels or sequentially and vertically adjacent blue sub-pixels; each of the sub-pixel groups is divided into two adjacent sub-pixel units;
a control element comprising one or more processors, and a memory storing computer executable instructions, wherein when the computer executable instructions are executed by the one or more processors, the one or more processors perform steps comprising:
receiving an image input signal and calculating an average gray scale value of each of the sub-pixel groups according to the image input signal; and
obtaining a corresponding driving voltage pair according to the average gray scale value; wherein the driving voltage pair comprises a high driving voltage and a low driving voltage; and
a driving element connected to the control element and the display panel, respectively; wherein the driving element is configured to drive two sub-pixel units of the corresponding sub-pixel group according to the driving voltage pair;
wherein the one or more processors further execute the computer executable instructions to perform steps in following units:
a determining unit configured to determine a gray scale range of the average gray scale value of each of the sub-pixel groups;
an obtaining unit configured to obtain a corresponding LUT according to the gray scale range;
wherein the obtaining unit is further configured to obtain the driving voltage pair using the corresponding LUT according to the gray scale range of each of the sub-pixel groups.
